(19) United States
(12) Patent Application Publication
(10) Pub. No.: US 2026/0058174 A1
(43) Pub. Date: Feb. 26, 2026

(54) SEALING AIR AND PURGE SUPPLY IN A FUEL CELL SYSTEM VIA AN AIR RESERVOIR

(71) Applicant: CELLCENTRIC GMBH & CO. KG, Kirchheim (DE)

(72) Inventor: Armin MÜTSCHELE, Kirchheim/Teck-Nabern (DE)

(21) Appl. No.: 19/104,126

(22) PCT Filed: Aug. 24, 2023
(86) PCT No.: PCT/EP2023/073231

§ 371 Date: Feb. 14, 2025

(30) Foreign Application Priority Data
Aug. 25, 2022 (DE) 10 2022 208 794.1

(51) Int. Cl. H01M 8/04223; B60L 58/30; H01M 8/04119; H01M 8/04228; H01M 8/04303; H01M 8/0432; H01M 8/04492; H01M 8/04746

(52) U.S. Cl. CPC H01M 8/04231; H01M 8/04156; H01M 8/04228; H01M 8/04253; H01M 8/04303; H01M 8/0432; H01M 8/04492; H01M 8/04753; B60L 58/30; H01M 2250/20

(57) ABSTRACT

Method for securing an in particular shut-down fuel cell system, comprising determining status data, wherein the status data describe an influencing factor for condensation of moisture in the fuel cell system; and providing sealing air in at least one part of the fuel cell system and/or purging the at least one part of the fuel cell system by means of a gas from a pressure vessel of the vehicle, based on the status data.

The present invention relates to a method for securing a shut-down fuel cell system, a system for monitoring, purging a part of a fuel cell system and/or providing sealing air in a part of the fuel cell system, and a computer program or computer program product.

Under certain conditions, condensate or condensation water usually forms in the parts of the fuel cell system. These fuel cell systems are usually designed to remove condensate or condensation water that occurs during operation of the fuel cell system. Typically, fuel cell systems are no longer able to remove condensate or condensation water, when in particular the fuel cell-powered vehicle or fuel cell electric vehicle (FCEV) is shut-down, especially when parts of the fuel cell system are powered-down or inactivated.

The object of the present invention is, in particular among other things, to improve a reliability of a fuel cell system, in particular when one fuel cell of the fuel cell system, a majority of the fuel cells of the fuel cell system or a fuel cell vehicle (FCEV) having the fuel cell system is shut-down, in particular when at least a part, in particular when a majority of the fuel cell system is powered-down.

This object is achieved according to the teaching of the independent claims. Various embodiments and developments of the invention are the subject matter of the dependent claims. A first aspect of the solution presented here relates to a method for securing a fuel cell system, in particular for securing a shut-down fuel cell system. In some embodiments of the invention, the method comprises determining status data. In some embodiments, the status data describe a, in particular external, status of at least a part of the fuel cell system. In some embodiments, the method includes providing sealing air in at least one part of the fuel cell system and/or purging the at least one part of the fuel cell system based on the status data.

Preferred exemplary embodiments of the method are described hereinafter, which in each case, unless expressly excluded or technically impossible, can be combined as desired with one another and with other aspects of the present solution, which will be described in the following.

In some embodiments, the method further comprises determining fuel cell system data. In some embodiments, the fuel cell system data describe an in particular internal status of at least a part of the fuel cell system. In some embodiments, the provision of sealing air in at least one part of the fuel cell system and/or purging of the at least one part of the fuel cell system is based, in particular additionally, on the fuel cell system data.

In some embodiments, the method includes providing sealing air in at least one part of the fuel cell system and/or purging the at least one part of the fuel cell system based on the status data and/or the fuel cell system data.

In some embodiments, providing sealing air and/or purging is carried out by means of a gas from a pressure vessel, in particular from a compressed air reservoir or compressed air tank. In some embodiments, providing sealing air and/or the purging by means of a gas is additionally or alternatively carried out from a pressure vessel, in particular from a compressed air reservoir or compressed air tank, in particular from a pressure vessel which is usually used for a task other than purging and/or provision in fuel cell systems, in particular in vehicles with fuel cell systems and/or FCEV. In one embodiment, the pressure vessel is used at least additionally (with respect to its other and/or usual uses) for providing sealing air and/or for purging by means of sealing air, in particular by means of a gas, or the pressure vessel is designed for this purpose. In one embodiment, no pressure vessel is used, which is only used for providing sealing air and/or purging by means of a gas or is only designed for this purpose. In one embodiment, the pressure vessel is additionally configured to provide sealing air and/or purging as described herein.

In some embodiments, the method comprises shutting down the fuel cell system, in particular the shutting down of the (sub-)systems of the fuel cell system, so that the system is in a rest status or a “shut-down” status. In some embodiments, the method comprises determining whether the fuel cell system is shut-down, in particular determining whether those parts of the fuel cell system are deactivated, in particular corresponding to a status of the fuel cell system that is (usually) considered or deemed to be “shut-down”. In some embodiments, determining status data and/or determining fuel cell system data is carried out after the fuel cell system is shut-down, in particular as long as the fuel cell system is in a shut-down status. In particular, in some embodiments, determining status data may include the determination of a “shut-down” status of the fuel cell system. The term “shut-down” as used herein may in some embodiments be understood to mean that the fuel cell system is no longer able to provide (dry) air, in particular (dry) gas, in particular is no longer able to protect all or at least some parts from condensate formation, in particular by an air and/or gas flow through at least part of the fuel cell system.

In some embodiments, “gas” is understood herein to mean in particular a fluid, more particularly a pure gas or a gas mixture. In some embodiments, “gas” means an inert fluid, in particular an inert gas or inert gas mixture. In some embodiments, “gas” herein means a fluid having a relative humidity of less than 2%, dry gas or dry air, in particular a fluid having a trace humidity of less than 200 ppm or less than 60 ppm.

Advantageously, in some embodiments, in particular by “purging out” condensate or condensate accumulations, in particular by “purging out” moist air and/or gas having a high moisture content, penetration of (condensed) water and thus in particular a fault in the high-voltage system of the fuel cell system, HV insulation faults and/or corrosion in the system can be prevented. Further advantageously, in some embodiments, this can be done without starting up parts or the (entire) fuel cell system.

In some embodiments, the status data comprise or describe at least one value from the group of service life of the fuel cell system, an activation status of the fuel cell system, in particular whether the fuel cell system is shut-down or not, a wind direction, in particular a wind direction with respect to the main axis of the fuel cell system, a parking position of the fuel cell system, in particular a GPS position, an outside temperature and an outside temperature profile, in particular at the fuel cell system. In some embodiments, other values, in particular publicly available values, in particular from (public) databases regarding the weather and/or weather forecasts, in particular at a determined “parking” position of the fuel cell system, can also be included or described by the status data. In other words, in some embodiments, at least part of the status data is determined from an external data source, in particular an available online data source is used, in particular data from a weather service, such as in particular temperature data, data on wind speed and/or wind direction, further in particular forecasts for said data, in particular at the position of the fuel cell system or at the position of the fuel cell system.

Advantageously, in some embodiments, this can make it possible for a current status and/or a future status, in particular a corresponding value for a status, of the fuel cell system, in particular at its (current) position, to be determined or determinable. In other words, in some embodiments, a prognosis for the status of the fuel cell system can advantageously be determined in this way. In some embodiments, the prognosis can be used to determine (in particular based on the status data and/or the fuel cell system data) whether a formation of condensate or condensation water, in particular a freezing of the formed condensate, is to be expected for at least one part of the fuel cell system or whether a probability of the formed condensate freezing is higher than a predetermined probability.

In some embodiments, determining status data and/or determining fuel cell system data includes predicting the development of the values of these data.

Advantageously, in addition to an actual status of the fuel cell system, the prediction of an actual status of the fuel cell system can be supplemented or is supplemented by this.

In some embodiments, determining status data comprises combining multiple status data, in particular deriving or calculating forecasts for at least one of the values (described by the status data) and/or using the determined values with a mathematical model, artificial intelligence or a lookup table to determine a status of the fuel cell system or a forecast of the status of the fuel cell system, in particular to determine whether the fuel cell system is or will be exposed to conditions that lead or can lead to freezing of condensate.

Advantageously, in some embodiments, this makes it possible to determine whether the fuel cell system has been powered-down, in particular whether the fuel cell system has been powered-down. In other words, in some embodiments, the status data can be used to determine whether the fuel cell system, in particular its parts, is or will be exposed to environmental conditions that may cause or trigger the freezing of condensate or condensation water.

In some embodiments, the fuel cell system data include or describe at least one value from the group of: moisture content of at least one part of the fuel cell system, in particular a relative humidity, condensate formation and/or condensate quantity in the at least one part of the fuel cell system, temperature of the at least one part of the fuel cell system and temperature profile of the at least one part of the fuel cell system.

Advantageously, in one embodiment this allows that the different cooling behavior of the various components of the fuel cell system is or can be taken into account and/or that purging of the components of the fuel cell system can be or will be improved according to their cooling behavior.

In some embodiments, purging is carried out by means of gas, in particular by means of compressed air and/or by means of hydrogen, and/or by means of an inert gas, in particular nitrogen or argon. In some embodiments, providing “sealing air” is carried out by means of gas, in particular by means of compressed air and/or hydrogen, and/or a gas, in particular an inert gas, in particular nitrogen or argon. Further advantageously, in some embodiments, this can prevent parts of the fuel cell system in which condensate can form from freezing, especially at low outside temperatures (at or below freezing point). The term “sealing air”, as used herein, should preferably be understood as a fluid, fluid mixture, in particular gas or gas mixture. “Sealing air” is preferably to be understood without restriction of generality; in particular, “sealing air” is not limited to “air” in the colloquial sense.

In some embodiments, the at least one part of the fuel cell system is on a cathode side of the fuel cell system or a cathode branch of the fuel cell system or on an anode side of the fuel cell system or an anode branch of the fuel cell system. In some embodiments, purging or providing sealing air on the cathode side or in the cathode branch is carried out by means of compressed air, an inert gas, in particular nitrogen, and on an anode side or in the anode branch by means of hydrogen and/or by means of an inert gas, preferably by means of hydrogen.

Advantageously, in some embodiments, this can make it possible for the parts of the fuel cell system to be purged with a gas that is suitable for their properties or that appropriate sealing air is or can be provided.

In some embodiments, purging of at least one part of the fuel cell system or providing sealing air in the at least one part of the fuel cell system is carried out by means of a controllable, in particular by means of a feedback-controllable, valve control, wherein the valve control has at least one valve.

Advantageously, in some embodiments, this can make it possible for different parts of the fuel cell system to be individually purged or for different parts of the fuel cell system to be individually supplied with sealing air, in particular in parallel and/or sequentially.

In some embodiments, the method is performed at a predetermined time after the fuel cell system is shut-down and/or at a predetermined (time) interval. Alternatively or additionally, the method is carried out randomly (in terms of time) or continuously.

In some embodiments, the method comprises repeating the steps described herein, in particular, in some embodiments, determining status data and/or of fuel cell system data and providing sealing air or purging based on the status data and/or the fuel cell system data is repeated, in particular as long as the fuel cell system is shut-down.

In some embodiments, the method is carried out without starting the (entire) fuel cell system, in particular without starting or commissioning an electric turbocharger of the fuel cell system. Advantageously, in some embodiments, this can limit or prevent (heavy) noise development due to the starting of the entire system, and corresponding surprise or irritation of people in the surrounding area due to this noise. Rather, in some embodiments, in the event of a risk of freezing, it can be avoided that the fuel cell system has to be “woken up” in order to be able to purge at least a part of the fuel cell system and/or to provide sealing air for this part. In some embodiments, the method is carried out when the fuel cell system is powered-down, in particular is in partial operation and/or in an operating status that cannot (no longer) prevent the formation of condensate in at least parts of the system.

In some embodiments, the fuel cell system is a mobile fuel cell system, in particular a fuel cell system that at least partially operates a vehicle or at least partially supplies electrical energy and/or heat to the vehicle. In some embodiments, the term “vehicle” is to be understood in particular in such a way that the fuel cell system is designed to be mobile, in particular serves at least partially to move the vehicle or is at least involved in generating the energy for moving the vehicle and/or is used to supply power or energy to the vehicle, in particular as an “auxiliary power unit” (APU) or the like. In some embodiments, “vehicle” is understood to mean a mobile means of transport and/or mobile means of transportation, in particular a commercial vehicle, a truck, a passenger car, a ship or an aircraft, in particular an airplane, in particular an eVTOL or eSTOL, or a gyroplane, in particular with a fuel cell system. In some embodiments, the method includes shutting down the vehicle, in particular shutting down the systems of the vehicle so that the vehicle is in a resting status or a “shut-down” status. In some embodiments, the method comprises determining whether the vehicle is shut-down, in particular determining whether those parts of the vehicle and/or those parts of the fuel cell system are deactivated, in particular corresponding to a status of the vehicle that is (usually) considered to be “shut-down”. In some embodiments, the determination of status data and/or the determination of fuel cell system data is carried out after the vehicle is shut-down, in particular as long as the vehicle is in a shut-down status. In particular, in some embodiments, determining status data may include determining a “shut-down” status of the vehicle.

A second aspect of the solution presented here relates to a system for monitoring, purging at least a part of a fuel cell system and/or providing sealing air in at least a part of the fuel cell system, in particular a fuel cell system of a vehicle. In some embodiments, the system is configured to perform a method described herein.

Advantageously, in some embodiments, this may enable the fuel cell system to be or remain startable, in particular under conditions that typically lead to freezing of condensate or increased formation of condensate, in particular conditions that (typically) lead to condensate triggering a fault in the fuel cell system if the condensate is not removed or cannot be removed, in particular if the fuel cell system and/or the vehicle with fuel cell system does not have a system described herein.

The features and advantages explained with respect to the first aspect of the invention also apply correspondingly to the further aspects of the invention.

The method according to the first aspect is preferably designed for execution by means of the system of the invention according to the second aspect, in particular an embodiment thereof described herein. The system according to the invention is preferably designed to carry out the method according to the first aspect, in particular an embodiment thereof described herein.

In some embodiments, the system, in particular the fuel cell system and/or the vehicle with fuel cell system, has a pressure vessel or compressed air reservoir or compressed air tank, in particular an additional or an extended pressure vessel. In some embodiments, the pressure vessel is designed, in particular additionally designed, to purge the at least one part of the fuel cell system with gas or to supply the at least one part of the fuel cell system with sealing air, in particular in a controllable manner. “Additionally” as used herein may, in some embodiments, refer to a pressure vessel in the vehicle that is typically used for pressurizing brakes or the like, but is not configured for purging and/or providing sealing air. In some embodiments, the system comprises at least one controllable valve (with a valve control) which is configured to regulate a gas flow from the pressure vessel. In some embodiments, the system, in particular the fuel cell system and/or the vehicle with fuel cell system, has a compressed air reservoir, in particular an extended compressed air reservoir, in particular with respect to a vehicle that does not have a system described herein, further in particular that does not have a system that is configured to carry out a method described herein.

Advantageously, this makes it possible for parts of the system to be purged or for sealing air to be provided in parts of the system independently, in particular without having to activate parts of the fuel cell system, in particular without having to activate the entire fuel cell system. In one embodiment, the fuel cell system can advantageously remain in a powered-down status, in particular the system can advantageously (nevertheless) provide purging or sealing air.

In some embodiments, the system comprises a plurality of valves, in particular a plurality of controllable valves, in particular with a valve control. In some embodiments, at least one valve of the plurality of valves is connected to an engine housing and/or a turbine side of an electric turbocharger (ETC), a valve of the anode knock-out (AKO), in particular a drain valve, respectively, in particular for purging the mentioned parts or for providing sealing air in the mentioned parts, in particular such that a connection between the pressure vessel and the respective parts of the fuel cell system is or will be influenced by the valves, in particular is or will be regulated. In some embodiments, at least one valve of the plurality of valves is connected to a purge valve of the anode knock-out, in particular to a downstream anode knock-out manifold and/or heating line to the exhaust pipe, a cathode knock-out (CKO), in particular to a drain valve of the cathode separator, in particular in an air processing unit (APU) of the fuel cell system, respectively, further in particular to a downstream heating line of the cathode knock out, to the exhaust pipe, in particular for purging the parts mentioned or for providing sealing air in the parts mentioned, in particular such that a connection between the pressure vessel and the respective parts of the fuel cell system is influenced by the valves, in particular by regulating them. In some embodiments, at least one valve of the plurality of valves is connected to a fuel cell stack cathode side, a fuel cell stack anode side and/or a hydrogen recirculation blower (HRB), in particular a hydrogen recirculation blower of an anode feed unit (AFU) of the fuel cell system, in particular for purging the mentioned parts or for providing sealing air in the mentioned parts, in particular such that a connection between the pressure vessel and the respective parts of the fuel cell system is influenced by the valves, in particular by regulating them.

Advantageously, in some embodiments, this can make it possible for the parts of the fuel cell system, in particular the parts of the fuel cell system mentioned, to be purged and/or supplied with sealing air individually, in particular when predetermined values for the parts of the fuel cell system are undershot or exceeded, in accordance with the fuel cell system data, in particular according to their (individual) cooling behavior, in particular their temperature profile and/or their current temperature, according to the amount of condensate or condensation water present in this part, according to the degree of humidity prevailing in this part and/or depending on the status data (as described herein). Advantageously, in some embodiments, the fuel cell system can also be secured in this way, in particular in such a way that starting the fuel cell system is made easier, faults in the fuel cell system, in particular HV faults, are prevented or can be prevented and/or starting the fuel cell system (at all) is possible or enabled. The term “undershot” may, in some embodiments, refer to falling below a predetermined value, in particular for a temperature, a forecast for a temperature, or the like. The term “exceeded” may in some embodiments refer to exceeding a predetermined value, in particular a condensate content, a (relative) humidity, a water content, a cooling rate or the like.

A system and/or a means within the meaning of the present invention can be designed in terms of hardware and/or software, in particular at least one in particular digital, processing unit, in particular a microprocessor unit (CPU), graphics card (GPU) or the like, preferably data-or signal-connected to a storage and/or bus system, and/or one or more programs or program modules. The processing unit may be configured to execute instructions implemented as a program stored in a storage system, to detect input signals from a data bus, and/or to provide output signals to a data bus. A storage system may comprise one or more, in particular different, storage media, in particular optical, magnetic, solid-status and/or other non-volatile media. The program can be designed in such a way that it embodies or is capable of carrying out the methods described here, so that the processing unit can carry out the steps of such methods and thus in particular can operate or monitor, in particular secure, a fuel cell system.

In some embodiments, the system comprises means for determining status data, means for determining fuel cell system data, and means for providing sealing air and/or means for purging at least a part of the fuel cell system.

In some embodiments, the method is carried out only using the system described herein, in particular a pressure vessel and the means for acquiring status data, the means for acquiring fuel cell system data and the means for providing sealing air or the means for purging, in particular without the use of systems, devices, modules or the like that are or will be activated when the fuel cell system and/or the vehicle with the fuel cell system is not shut-down, but in particular started. In some embodiments, means for providing sealing air and/or means for purging refer to at least one processing unit, in particular a valve control, which is configured to open and/or close the at least one valve, in particular when a determined value of the status data and/or the fuel cell system data exceeds a predetermined value or falls below a predetermined value. In some embodiments, the at least one processing unit, in particular the valve control, is integrated into the at least one valve or is an external processing unit with respect to the valve, which is configured in particular to control the at least one valve.

In one embodiment, a computer program product can have, in particular be, a storage medium, in particular a computer-readable and/or non-volatile storage medium, for storing a program or instructions or with a program or instructions stored thereon. In one embodiment, executing this program or of these instructions by a system or a controller, in particular a computer or an arrangement of several computers, causes the system or the controller, in particular the computer(s), to carry out a method described here or one or more of its steps, or the program or the instructions are configured to do so.

The computer program can in particular be stored on a non-volatile data carrier. Preferably the data carrier is in the form of an optical data carrier or a flash storage module. This can be advantageous if the computer program as such is to be handled independently of a processor platform on which the one or more programs are to be executed. In another implementation, the computer program can be present as a file on a data processing unit, in particular on a server, and can be downloaded via a data connection, for example the Internet or a dedicated data connection, such as a proprietary or local network. In addition, the computer program can have a plurality of individual interacting program modules. In particular, the modules can be configured or at least used in such a way that they are executed in the sense of distributed computing on different devices (computer or processor units) that are geographically remote from one another and connected to one another by a data network.

The system can accordingly have a program memory in which the computer program is stored. Alternatively, the system can also be set up to access a computer program available externally, for example on one or more servers or other data processing units, via a communication connection, in particular in order to exchange data therewith, which data are used during the execution of the method or computer program or represent outputs of the computer program.

In one embodiment, one or more, in particular all, steps of the method are carried out completely or partially automatically, in particular by the controller or its means. It is within the scope of the invention that the method steps described above are carried out in a different order and/or method steps are combined and/or one method step is integrated into another method step.

As possibly used herein, the terms “comprises,” “contains,” “includes,” “encloses,” “has,” “with,” or any other variant thereof are intended to cover non-exclusive inclusion. For example, a method or a device that comprises or has a list of elements is not necessarily restricted to these elements, but may include other elements that are not expressly listed or that are inherent to such a method or such a device.

Furthermore, unless expressly stated to the contrary, “or” refers to an inclusive or and not to an exclusive “or”. For example, a condition A or B is met by one of the following conditions: A is true (or present) and B is false (or absent), A is false (or absent) and B is true (or present), and both A and B are true (or present).

The terms “a” or “an” as used herein, are defined in the meaning of “one or more”. The terms “another” and “a further” and any other variant thereof are to be understood to mean “at least one other”.

The term “configured” or “designed” to perform a specific function (and respective modifications thereof), possibly used herein, is to be understood to mean that the corresponding device or a component thereof is already provided in a design or setting in which it can execute the function or that it is at least adjustable-namely configurable-so that it can execute the function after corresponding adjustment. The configuration can take place, for example, via a corresponding setting of parameters of a process course or of switches or the like for activating or deactivating functionalities or settings. In particular, the device can have multiple predetermined configurations or operating modes, so that the configuration can be carried out by selecting one of these configurations or operating modes.

Further advantages, features, and possible applications of the present invention result from the following detailed description in conjunction with the figures.

In particular

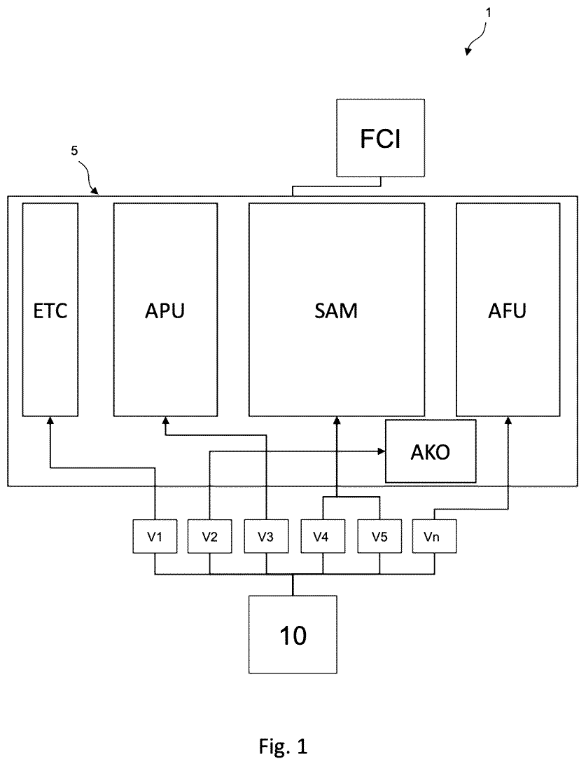

FIG. 1 schematically shows a system according to an embodiment of the present invention; and

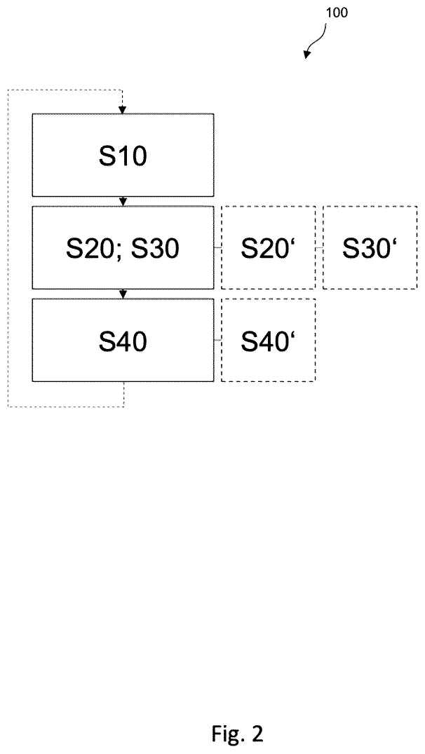

FIG. 2 shows a flowchart to illustrate a preferred embodiment of the method according to the invention.

In the figures, the same reference numerals denote the same, similar or corresponding elements. Elements depicted in the figures are not necessarily represented to scale. Rather, the various elements shown in the figures are presented in such a way that their function and general purpose can be understood by those skilled in the art. Connections and couplings, shown in the figures, between functional units and elements can also be implemented as an indirect connection or coupling, unless expressly stated otherwise. Functional units can be implemented in particular as hardware, software or a combination of hardware and software.

FIG. 1 schematically shows a system 1 with a fuel cell system 5. The system 1 has valves V1 to Vn, each of which is connected to a part of the fuel cell system 5. Furthermore, the system 1 has a pressure vessel 10 which is connected to parts of the fuel cell system 5 via valves V1 to Vn, such that the valves V1 to Vn provide a quantity of compressed air from the pressure vessel 10, in particular regulate its flow to a part of the fuel cell system 5 or are designed to do so and/or provide a quantity of compressed air from the pressure vessel 10 or are configured to do so, in particular as sealing air in a part of the fuel cell system 5 connected via the respective valve V1 to Vn. Valve V1 in FIG. 1 is designed to purge the at least one part of the fuel cell system 5 or to provide sealing air thereto, here by way of example to at least one part of the electric turbocharger ETC. Valve V2 in FIG. 1 is designed to purge the at least one part of the fuel cell system 5 or to provide sealing air thereto, here, for example, at least one part of the anode knock-out AKO. Valve V3 in FIG. 1 is designed to purge the at least one part of the fuel cell system 5 or to provide sealing air thereto, here, for example, at least one part of the air processing unit APU. Valve V4 in FIG. 1 is designed to purge the at least one part of the fuel cell system 5 or to provide sealing air thereto, here, for example, at least one part of the fuel cell stack assembly module (SAM). Valve V5 in FIG. 1 is designed to purge the at least one part of the fuel cell system 5 or to provide sealing air thereto, here, for example, at least another part of the fuel cell stack assembly module (SAM). In some embodiments, the system 1 comprises a plurality of valves, as exemplified in FIG. 1 by the designation Vn. Valve Vn in FIG. 1 is designed to purge the at least one part of the fuel cell system 5 or to provide sealing air thereto, here, for example, at least one part of the anode feed unit AFU. Furthermore, FIG. 1 shows a fuel cell interface FCI, which can be used in particular (in some embodiments) to determine fuel cell system data, which is in particular configured for this purpose, and is in particular connected thereto in data communication.

FIG. 2 schematically shows a method 100 for securing a fuel cell system 5 of a vehicle. The method 100 comprises shutting-down the fuel cell system S10 or determining whether the fuel cell system is shut-down, determining status data S20 and determining fuel cell system data S30. In some embodiments, this may comprise determining a temperature S20′ and/or determining a relative humidity S30′, which is indicated by the dashed lines in FIG. 2. Based on the (determined) status data and the (determined) fuel cell system data, if a (predetermined) value for the determined status data and/or the determined fuel cell system data is undershot or exceeded, at least a part of the fuel cell system is purged S40, in some embodiments sealing air S40′ is provided in the at least a part of the fuel cell system. Depending on the part of the fuel cell system, purging and/or sealing air can be provided, which is shown as an example in FIG. 2 by the dashed line of S40′. Furthermore, the method can be repeated as often as desired, in particular as long as the fuel cell system is shut-down, as shown here by a dashed arrow.

While at least one exemplary embodiment has been described above, it is to be noted that a large number of variations thereto exist. It is also to be noted that the exemplary embodiments described only represent non-limiting examples, and are not intended to restrict the scope, the applicability, or the configuration of the devices and methods described herein. Rather, the preceding description will provide those skilled in the art with guidance for implementing at least one exemplary embodiment, wherein it is apparent that various changes in the operation and arrangement of elements described in an exemplary embodiment may be made without departing from the scope of the subject matter defined in the appended claims and their legal equivalents.

### LIST OF REFERENCE NUMERALS

1 system
5 fuel cell system
10 pressure vessel/compressed air storage
V1 to Vn valve
APU air processing unit
AFU anode feed unit
AKO anode knock-out
CKO cathode knock-out
ETC electric turbocharger
FCI fuel cell interface
SAM stack assembly module
100 method
S10 shut-down
S20 determination of status data
S20′ determination of a temperature
S30 determination of fuel cell system data
S30′ determination of relative humidity
S40 purge
S40′ provision of sealing air.

What is claimed is:

1. A method for securing an in particular shut-down fuel cell system, comprising:
determining status data, wherein the status data describe an influencing factor for condensation of moisture in the fuel cell system; and
providing sealing air in at least one part of the fuel cell system and/or purging the at least one part of the fuel cell system by means of a gas from a pressure vessel of the vehicle, which is additionally configured for this purpose, based on the status data.

2. The method according to claim 1, wherein the method comprises determining fuel cell system data of the at least one part of the fuel cell system, wherein the fuel cell system data describe a status of the at least one part of the fuel cell system; and wherein providing sealing air in the at least one part of the fuel cell system and/or purging the at least one part of the fuel cell system by means of a gas from a pressure vessel of the vehicle takes place based on the fuel cell system data.

3. The method according to claim 1, wherein the status data comprise at least one value from the group of service life of the fuel cell system, a wind direction, a position, an outside temperature and an outside temperature profile and/or wherein the fuel cell system data comprise at least one value from the group of: moisture content of at least one part of the fuel cell system, condensate formation and/or condensate quantity in the at least one part of the fuel cell system, temperature of the at least one part of the fuel cell system and temperature profile of the at least one part of the fuel cell system.

4. The method according to claim 1, wherein purging and/or providing sealing air is carried out by means of a gas, in particular by means of hydrogen and/or by means of compressed air, in particular by means of an inert gas, in particular by means of nitrogen or argon.

5. The method according to claim 1, wherein the at least one part of the fuel cell system is a cathode branch and purging and/or provision is carried out by means of a gas, in particular by means of an inert gas and/or by means of compressed air, or wherein the at least one part of the fuel cell system is an anode branch of the fuel cell system and purging and/or providing is carried out with an inert gas and/or hydrogen.

6. The method according to claim 1, wherein purging of the at least one part of the fuel cell system or providing sealing air in the at least one part of the fuel cell system is carried out by means of a controllable, in particular regulable, valve control which has at least one valve, in particular by controlling, in particular regulating the at least one valve, in particular by opening or closing the at least one valve.

7. The method according to claim 1, wherein at least part of the status data is determined from an external data source.

8. The method according to claim 1, wherein the method is carried out at predetermined times after shutting-down the vehicle or in a predetermined time interval.

9. The method according to claim 1, wherein the method comprises repeating, on the one hand, the determining and, on the other hand, the purging and/or providing.

10. The method according to claim 1, wherein the method is carried out when the fuel cell system is shut-down or during partial operation of the fuel cell system.

11. A system for monitoring, purging at least a part of a fuel cell system and/or providing sealing air in a part of the fuel cell system, which system is configured to carry out a method according to claim 1.

12. The system according to claim 1, wherein the system comprises a pressure vessel which is in particular additionally configured to purge the at least one part of the fuel cell system with gas or to supply the at least one part of the fuel cell system with sealing air, in particular by means of a valve control.

13. The system according to claim 11, wherein the system, in particular a valve control arrangement, has a plurality of valves, wherein the valves are arranged in fluid connection between the pressure vessel and the at least one part of the fuel cell system and the system, in particular the valve control arrangement, is further configured to influence, in particular to regulate, a gas quantity.

14. A computer program or computer program product, wherein the computer program or computer program product contains instructions, in particular stored on a computer-readable and/or non-volatile storage medium, which instructions, when executed by one or more computers or by a system according to claim 11, cause the computer(s) or the system to carry out a method comprising:
determining status data, wherein the status data describe an influencing factor for condensation of moisture in a fuel cell system; and
providing sealing air in at least one part of the fuel cell system and/or purging the at least one part of the fuel cell system by means of a gas from a pressure vessel of the vehicle, which is additionally configured for this purpose, base on the status data.

15. The method according to claim 2, wherein the status data comprise at least one value from the group of service life of the fuel cell system, a wind direction, a position, an outside temperature and an outside temperature profile and/or wherein the fuel cell system data comprise at least one value from the group of: moisture content of at least one part of the fuel cell system, condensate formation and/or condensate quantity in the at least one part of the fuel cell system, temperature of the at least one part of the fuel cell system and temperature profile of the at least one part of the fuel cell system.

16. The method according to claim 2, wherein purging and/or providing sealing air is carried out by means of a gas, in particular by means of hydrogen and/or by means of compressed air, in particular by means of an inert gas, in particular by means of nitrogen or argon.

17. The method according to claim 3, wherein purging and/or providing sealing air is carried out by means of a gas, in particular by means of hydrogen and/or by means of compressed air, in particular by means of an inert gas, in particular by means of nitrogen or argon.

18. The method according to claim 2, wherein the at least one part of the fuel cell system is a cathode branch and purging and/or provision is carried out by means of a gas, in particular by means of an inert gas and/or by means of compressed air, or wherein the at least one part of the fuel cell system is an anode branch of the fuel cell system and purging and/or providing is carried out with an inert gas and/or hydrogen.

19. The method according to claim 3, wherein the at least one part of the fuel cell system is a cathode branch and purging and/or provision is carried out by means of a gas, in particular by means of an inert gas and/or by means of compressed air, or wherein the at least one part of the fuel cell system is an anode branch of the fuel cell system and purging and/or providing is carried out with an inert gas and/or hydrogen.

20. The method according to claim 2, wherein purging of the at least one part of the fuel cell system or providing sealing air in the at least one part of the fuel cell system is carried out by means of a controllable, in particular regulable, valve control which has at least one valve, in particular by controlling, in particular regulating the at least one valve, in particular by opening or closing the at least one valve.
